(19) United States
(12) Patent Application Publication
(10) Pub. No.: US 2004/0217323 A1
(43) Pub. Date: Nov. 4, 2004

(54) Powdery fire retardant and method of preparing fire retardance foam using it

(75) Inventor: Hitoshi Matsushita, Mitoyo-gun (JP)

Correspondence Address: Norris, McLaughlin & Marcus P.A., 30th Floor, 220 East 42nd Street, New York, NY, 10017, US

(73) Assignee: MATSUSHITA TRADING Co. Ltd., Kagawa (JP)

(21) Appl. No.: 10/417,767

(22) Filed: Apr. 17, 2003

(51) Int. Cl. A62D 1/00

(52) U.S. Cl. 252/8.05

(57) ABSTRACT

The present invention provides a powdery fire retardant which enables an excellent fire retardant foam to be easily prepared. The present invention also provides a method of preparing a fire retardant foam by using the powdery fire retardant.

The powdery fire retardant comprises ammonium chloride, pentaerythritol, dicyandiamide and propylene glycol but does not contain sodium tungstate, ammonium sulfate, urea formaldehyde and ammonium monophosphate.

The method of preparing a fire retardant foam comprises mixing the powdery fire retardant with a foamable material and then foaming the resultant mixture.

### TECHNICAL FIELD

The present invention relates to a powdery fire retardant and a method of preparing fire retardant foam using it.

### BACKGROUND TECHNOLOGY

Conventionally, a foam such as urethane foam is broadly used as industrial material, for example, a cushioning material for an automobile seat, a building insulating material and the like.

However, a fire retardant property of the foam such as urethane foam is very poor, therefore the foam burns and a melted part of it drops to cause a flame spread to other materials. It is conventionally difficult to give a fire retardant property to the foam such as urethane foam. Therefore, for example, when a cigarette end drops on a fire-retardant or flameproof seat cover covering a urethane foam seat of a car, the seat cover is gradually holed by the heat of the cigarette end even if the seat cover has the fire retardant property. Eventually, the urethane foam seat covered with the seat cover contacts the burning cigarette end so that a fire and a toxic gas are frequently caused. To avoid fire damage to a building insulating material and the like, it is desired that a fire retardant foam should be used as the building insulating material and the like. A self-extinguishing foam has been known whose combustion or flame can be stopped or extinguished in a short time when it is separated from a naked flame. However, a part of the self-extinguishing foam which contacts with the flame is easily melted or shrunken to form a concave portion or a hole therein. Therefore, the self-extinguishing foam is not satisfactory and an excellent fire retardant foam is still needed.

Furthermore, a method of impregnating an article with a fire retardant solution is known as a method of giving a fire retardant property to a foam. However, the method of impregnating an article with a fire retardant solution is troublesome because it is necessary to separately carry out a step of forming an article and a process of impregnating the article with the fire retardant solution. Therefore, it is desired that a foam having a fire retardant property should be easily producible.

Therefore, the object of the present invention is to provide a powdery fire retardant which is useful for easily preparing an excellent fire retardant foam and a method of preparing a fire retardant foam by using the retardant.

### DISCLOSURE OF INVENTION

The present inventor has conducted extensive research to achieve the above object, and found out that the powdery fire retardant comprising the specific ingredients can achieve the above object. The present invention has been completed based on this finding.

### EMBODIMENT FOR WORKING OF INVENTION

The present invention will be explained in more detail below.

The powdery fire retardant comprises ammonium chloride, pentaerythritol, dicyandiamide and propylene glycol, as fire retardant ingredients.

Ammonium chloride is a white crystal at normal temperature and is dissolved well in water.

Pentaerythritol is a colorless crystal at a normal temperature and is soluble in water.

Dicyandiamide is a colorless crystal at a normal temperature and is soluble in water.

Propylene glycol is a colorless viscous liquid at a normal temperature.

The powdery fire retardant of the present invention comprises from 20 to 40 parts by mass, preferably from 25 to 30 parts by mass, of pentaerythritol, from 20 to 40 parts by mass, preferably from 25 to 30 parts by mass, of dicyandiamide and from 0.2 to 0.6 parts by mass, preferably from 0.3 to 0.5 parts by mass, of propylene glycol per 100 parts by mass of ammonium chloride. The powdery fire retardant does not comprise sodium tungstate, ammonium sulfate, urea formaldehyde and ammonium monophosphate. The powdery fire retardant of the present invention is slightly yellowish. In this connection, propylene glycol is a viscous liquid. However, the fire retardant of the present invention is produced as a powder even if the viscous liquid is mixed with the other fire retardant ingredients. This is because it is assumed that the amount of propylene glycol added is very small, therefore, the propylene glycol adheres to the crystals of the fire retardant ingredients so that it is to be carried on the crystals and the powdery form can be maintained. The powdery fire retardant of the present invention can certainly have a fire retardant property if the respective amounts of the fire retardant ingredients are as stated above.

The powdery fire retardant of the present invention comprises merely four ingredients which are generally used in industry and are commercially available. Furthermore, the powdery fire retardant can be prepared by simply mixing these four gradients. Therefore, production costs can be held down.

The powdery fire retardant of the present invention may be dissolved in water to make an aqueous solution and then the water of the resultant aqueous solution may be evaporated to obtain a deposit. The deposit may be dried to obtain a solid fire retardant wherein the four ingredients of the fire retardant of the present invention are uniformly mixed. It is appropriate that the powdery fire retardant should be dissolved in water so as to become a concentration of from 0.1 to 40% by mass, preferably from 5 to 30% by mass, however, the concentration is not limited. Furthermore, the solid fire retardant can be quickly obtained if the evaporation and drying of the liquid fire retardant are carried out by heating at 70° C. or less in a water bath, a still and the like. If the evaporation and drying of the liquid fire retardant are carried out for a long time at more than 70° C., it should be noted that the fire retardant property may be decreased. The resultant solid fire retardant is finely ground into powder with a grinding bowl, mill mixer and the like. A suitable size of the powdery fire retardant is the size wherein the powdery fire retardant can be mixed with the foamable materials to obtain a fire retardant foam. For example, the size of the powdery fire retardant is, preferably from 1 to 50 μm, much preferably from 5 to 10 μm and, however, the size is not limited.

The liquid fire retardant of the present invention comprises from 1.0 to 30.0% by mass, preferably from 2.0 to 23.0% by mass, of ammonium chloride, from 0.5 to 10.0% by mass, preferably from 0.6 to 7.0% by mass, of pentaerythritol, from 0.5 to 10.0% by mass, preferably from 0.6 to 7.0% by mass, of dicyandiamide, from 0.01 to 0.2% by mass, preferably from 0.01 to 0.1% by mass, of propylene glycol, and from 49.8 to 97.99% by mass, preferably from 62.9 to 96.79% by mass, of water. The liquid fire retardant does not comprise sodium tangstate, ammonium sulfate, urea formaldehyde and ammonium monophosphate.

The four ingredients of the liquid fire retardant may be directly dissolved in water. However, a fire retardant solution having more effective fire retardant property can be obtained by the following procedure. First, ammonium chloride and pentaerythritol are dissolved in water to prepare an aqueous solution thereof. On the other hand, dicyandiamide is dissolved in water to prepare an aqueous dicyandiamide solution.

When these solutions are prepared, the temperature of the water is, for example, from 30 to 70° C., preferably from 36 to 65° C. A water temperature in excess of 70° C. should be avoided because the fire retardant property of the liquid fire retardant may be decreased. After sufficiently mixing the two solutions prepared, propylene glycol is added to the resultant mixture, which is stirred to dissolve propylene glycol. No special device is needed to mix the solutions. The solutions can be only mixed in a container with a stirring rod and the like so as to be uniform. Therefore, it is very easy to prepare the liquid fire retardant.

The prepared stock solution of the liquid fire retardant may be used as it is. 2 to 20-times-diluted stock solution with water may also be used so as to obtain a desirable fire retardant property.

A foam used in the method of preparing a fire retardant foam of the present invention is a polyurethane foam and other plastic foam such as a thermoplastic foam and thermosetting foam, however, the foam is not limited. Considering material costs, simpleness of production and the like, the polyurethane foam is preferable.

Polyurethane foam is generally prepared as follows. For example, a polyol as a main agent, a polyisocyanate as a curing agent, water and an additive such as a foaming assistant; a catalyst and the like are mixed to cause foaming reaction associated with urethane forming reaction, a gas blowing reaction with an exothermic heat, and the like. If the foam is made of a desirable shape, cast molding can be carried out by using a mold and the like. The polyol includes, for example, polypropylene glycol, polyethylene glycol, polyethylene adipate, polypropylene adipate and the like. The polyisocyanate includes, for example, tolylene diisocyanate, 4,4′-diphenylmethane isocyanate, 1,6-hexamethylene diisocyanate, isophorone diisocyanate and the like. The main materials of the polyurethane foam are a polyol having two or more active hydrogen groups (—OH group and the like) per one molecule and a polyisocyanate having two or more isocyanate groups (—NCO group) per one molecule. Therefore, the polyol and the polyisocianate may be mixed so that the range of a ratio of the active hydrogen group to the isocyanate group is from 0.5 to 1.5, preferably from 0.8 to 1.2. A molding method includes a spray foaming, a cast molding, a laminate foaming and the like. It is possible to carry out integral molding, foaming and the like, in situ.

Thermoplastic foam is generally prepared as follows. Thermoplastic material such as polystyrene, polyethylene and polyvinyl chloride is in a fused state. A crosslinker, curing agent, plasticizer and the like are added to the fused thermoplastic to adjust a viscosity thereof. The resultant mixture is foamed to form a thermoplastic foam. An inert gas (CO₂, N₂ and the like), a decomposable foaming agent (4,4-oxybisBSH, azodicarbonamide and the like) and a volatile organic liquid (propane, butane and the like) can be used to foam the thermoplastic. Such the gas, agent or liquid is caused to be added to thermoplastic materials or absorb under pressure.

Thermosetting foam is prepared as follows. For example, phenol resin, urea resin, melamine resin and the like is changed to a liquid state having a low viscosity, and then the liquid resin is polymerized or condensed to increase the viscosity of the liquid resin to a suitable level. Next, the above volatile organic liquid may be dissolved in the liquid resin to cause gas. Alternatively, the foaming agent such as Airset (product name, Takenaka Oil & Fat Co. Ltd.) of ABS system and water may also be mixed with the liquid resin to cause gas. The resin is foamed and cured to prepare a thermosetting foam. To produce the fire retardant foam by using the powdery fire retardant of the present invention, the powdery fire retardant is added to foamable materials prior to foaming, and after sufficiently mixing them, the resultant mixture may be made into foam. Preferably, the powdery retardant is mixed with a main agent.

A kit for preparing a urethane foam (Craft Resin Foaming Urethane Soft N (product name, Kokusai Chemical Corporation)) wherein a urethane foam can be simply molded is commercially available. The fire retardant foam can be prepared by using the kit. The kit is composing a liquid polyether polyol as a main agent and a liquid including 4,4′-diphenylmethane diisocyanate as a curing agent. Therefore, the powdery retardant of the present invention may be added to the main agent and be mixed. Then the curing agent may be added to the resultant mixture and be mixed. Finally the resultant mixture may be injected into a mold. An amount of the powdery fire retardant added to the materials is not limited. Optionally, the amount of the powdery fire retardant mixed with the foaming materials may vary depending on the foamable materials. When this amount is changed, a balance between the fire retardant property, hardness and cushioning properties of a foam should be taken into consideration. In the case of using the above kit, for example, the powdery fire retardant is mixed with the foamable materials in the amount of from 2 to 60% by mass, preferably from 5 to 20% by mass, based on the total mass of the urethane foamable materials. The higher the content of the powdery fire retardant is, the more the urethane foam tends to harden. Therefore, the fire retardant property, the hardness and the cushioning properties of a urethane foam can be suitably controlled by adjusting the amount of the fire retaradant within the above amount range.

The fire retardant foam of the present invention has an outstandingly excellent fire retardant property. Furthermore, the fire retardant foam does not require any additional process for preparing it, such as impregnating and the like, or any special technique and devices. Therefore, the fire retardant foam can be prepared with simple operations. Therefore, the powdery fire retardant can be added to the foamable materials in situ, a chemical reaction can be carried out to make foam and the fire retardant foam can be prepared to be directly molded and cured on building elements.

Alternatively, the method for preparing the fire retardant foam of the present invention may be a method comprising impregnating a foam is impregnated with an aqueous solution of the powdery fire retardant. In this case, first, the powdery fire retardant is dissolved in water to prepare an aqueous solution of the powdery fire retardant. A foam which has already molded into a desirable form is impregnated with the solution, and then the foam is dried, thus producing the fire retardant foam of the present invention.

The method of producing the fire retardant foam using impregnation is especially useful when a heating process takes a long time and an exothermic process is included. If the powdery fire retardant is subjected to a temperature of more than 70° C. for a long period of time, the fire retardant property may be decreased. Therefore, in a case where a thermoplastic foam and a thermosetting foam are prepared by a method wherein the materials are exposed to a high temperature, it is difficult to use the above method wherein the powdery fire retardant is added to the foamable materials before foaming and the fire retardant foam is produced as it is. For example, in a case where a foam is made from thermoplastic polyethylene as a main agent, the temperature of the process of melting polyethylene and mixing polyethylene with a foaming agent rises up to about 120 to 130° C. Furthermore, the temperature of the process of heating and foaming rises up to from about 200 to 210° C. In this connection, in the case of a process where polyurethane is foamed by using the commercial kit above, the temperature also rises up to an order of about 80 to 100° C. However, the temperature does not stay the same for a long time and thus the materials are naturally cooled. Therefore, the fire retardant property of the foam is hardly reduced by the heat.

It is suitable that an aqueous solution of the powdery fire retardant is dissolved in water in the amount of from 0.1 to 40% by mass, preferably from 5 to 30% by mass, based on the total mass of the aqueous solution of the powdery fire retardant. The powdery fire retardant of the present invention may be directly dissolved in water. Alternatively, ammonium chloride and pentaerythritol may be dissolved in water and dicyandiamide may be dissolved in another water and then the resultant solutions are mixed with each other so that the same composition ratio as the powdery fire retardant of the present invention is obtained. After two of the solutions are mixed, propylene glycol may be dissolved in the mixture to produce a stock solution. The stock solution may be diluted with water so as to have a concentration of from 0.1 to 40% by mass.

When a foam prepared in advance is impregnated with an aqueous solution of the fire retardant, it is preferable that the foam is repeatedly compressed and relaxed by hand so that the inside of the foam is impregnated with the solution of the fire retardant. After the resultant foam is sufficiently squeezed, the excessive fire retardant solution is removed from the resultant foam and then dried to obtain a fire retardant foam. The liquid fire retardant of the present invention may be used to produce a fire retardant foam in the same manner.

Furthermore, the aqueous solution of the powdery fire retardant can give a fire retardant property to various materials by post-processing. For example, the solution of the powdery fire retardant is applied to and is impregnated into building materials such as wood and the like, soft goods such as paper, cloth and the like, other synthesized materials, metals and the like to easily produce materials having a fire retardant property. The liquid fire retardant can also be used to produce materials having a fire retardant property in the same manner. In this connection, the semi-noncombustible material test conducted in accordance with ISO International Standard at the Japan Testing Center for Construction Materials was applied to a wood specimen. The wood specimen was prepared by which Hinoki Cypress was impregnated with the aqueous solution of the powdery fire retardant by compression. As a result, the wood specimen did not catch fire. Furthermore, no crack or hole penetrating the wood specimen, which spoils a fireproof property, could be observed. The total calorific value of the wood specimen for 10 minutes was 3.5 MJ/m². The total calorific value fell below the criterion of the semi-noncombustible material test, which is 8 MJ/m² or less. Therefore, the wood specimen could pass the semi-noncombustible material test.

As stated above, the powdery fire retardant of the present invention can give a fire retardant property to an existing foam by using very easy operations which require no special device. Therefore, the powdery fire retardant is very advantageous for preparing a foam having an excellent fire retardant property at building sites and production sites.

### EXAMPLE

The present invention will be explained in more detail below with reference to Examples and Reference Examples.

### Example 1

61.9 g of ammonium chloride, 17.6 g of pentaerythritol, 17.5 g of dicyandiamide and 0.2 g of propylene glycol were mixed to prepare a powdery fire retardant.

Then, 23 g of the resultant powdery fire retardant was added to 100 g of Solution A containing polyether polyol as a main agent contained in a commercial urethane foam kit described above (product name Foaming Urethane Soft N, Kokusai Chemical Corporation) and mixed well. Furthermore, 56 g of Solution B containing 4,4′-diphenylmethane isocyanate as a curing agent was added to the mixture and was mixed therewith. The resultant mixture was cast into a mold (internal dimension 6 cm×7 cm×20 cm) and was foamed to obtain a fire retardant foam, which was an almost rectangular parallelepiped slightly swelled like a pound cake and the size of which was about 6 cm×7 cm×20 cm. The resultant foam was cut into a piece having a length 6 cm×width 7 cm×thickness 1 cm to prepare a foam specimen A-1.

Fire Retardant Test

The edge of the foam specimen A-1 was pinched by a metal clip. The metal clip was fixed to a metal stick with an adhesive cellophane tape so that the foam specimen A-1 is hung down vertically from the metal stick. The foam specimen A-1 was placed at a distance of 250 mm away from the top of a nozzle of a gas burner (GT-5000, Yoshinaga Corporation). The foam specimen A-1 was exposed to a flame emitted from the burner under the conditions of a flame temperature of 1500° C., a room temperature of 25° C. and a humidity of 60%. The burning behavior of the foam specimen A-1 was then observed.

### Example 2

123.8 g of ammonium chloride and 35.2 g of pentaerythritol were dissolved in 1 liter of water. 35.0 g of dicyandiamide were dissolved in another 1 liter of water. Those two solutions were mixed and 0.4 g of propylene glycol was dissolved in the mixed solution to obtain a fire retardant solution. 150 ml of the resultant fire retardant aqueous solution was diluted with 850 ml of water to obtain the total volume of 1 liter of the diluted fire retardant solution.

A commercial polyurethane foam (flexible foam, Sinwa Corporation) was cut into a piece having a length 6 cm×width 7 cm×thickness 2 cm. In this connection, the thickness of the resultant piece of the commercial polyurethane foam is different from the thickness of the piece in Example 1. This is because the thickness of the commercial polyurethane foam was originally 2 cm and the commercial polyurethane foam was used as it is.

The resultant cut foam was compressed by hand and was relaxed by removing the hand to be impregnated with the diluted fire retardant solution. The resultant foam was sufficiently squeezed to drain the diluted fire retardant solution. Furthermore, the resultant foam was naturally dried to obtain a foam specimen A-2. The fire retardant test of the foam specimen A-2 was carried out in the same manner as in Example 1 except that a metal clip pinching the foam specimen A-2 was fixed to a metal stick with an adhesive cellophane tape so that the foam specimen A-2 was placed on the metal stick. This is because a foam specimen B-3 in Reference Example 3, which reference is compared with Example 2 below, was placed on the metal stick. If the foam specimen B-3 is hung from the metal stick, the foam specimen B-3 was melted and fell immediately due to the flame of the burner and the burning behavior of the foam specimen B-3 could not be sufficiently observed.

### Reference Example 1

A foam was obtained in the same manner as in Example 1 except that the powdery fire retardant was not added. The foam was cut into a piece having a length 6 cm×width 7 cm×thickness 1 cm to prepare a foam specimen B-1. The fire retardant test of the foam specimen B-1 was carried out in the same manner as in Example 1.

### Reference Example 2

Memory Foam (product name of polyurethane foam, Yamamitsu Oil Co., Ltd) was cut into a piece having a length 6 cm×width 7 cm×thickness 1 cm to prepare a foam specimen B-2. The fire retardant test of the foam specimen B-2 was carried out in the same manner as in Example 1. The Memory Foam is a commercial product which is a kind of urethane foam having a self-extinguishing property.

### Reference Example 3

A polyurethane foam (flexible foam, Sinwa Corporation) was cut into a piece having a length 6 cm×width 7 cm×thickness 2 cm to prepare a foam specimen B-3. The fire retardant test of the foam specimen B-3 was carried out in the same manner as in Example 2.

Result:

### Example 1

When the foam specimen A-1 was exposed to a flame emitted from the burner for about 45 seconds, the surface of the foam specimen A-1 was slightly carbonized and slightly browned. No flame came out of the foam specimen A-1, it did not burn at all and it was not holed.

### Example 2

When the foam specimen A-2 was exposed to a flame emitted from the burner for about 1 minute, the surface of the foam specimen A-2 was slightly carbonized and slightly browned. No flame came out of the foam specimen A-2, it did not burn at all and it was not holed.

### Reference Example 1

When the foam specimen B-1 was exposed to a flame emitted from the burner for about 10 seconds, the foam specimen B-1 strongly burned and the flame spread. Simultaneously, the foam specimen B-1 was melted to drip. 40 seconds after the flame was applied to the foam specimen B-1, the foam specimen B-1 dropped from the metal stick.

### Reference Example 2

When the foam specimen B-2 was exposed to a flame emitted from the burner for about 35 seconds, first, the foam specimen B-2 was slightly burned and the flame therein was extinguished. A large hole was formed in the foam specimen B-2 and the surface of the foam specimen B-2 was carbonized and changed to black.

### Reference Example 3

What is claimed is:

1. A powdery fire retardant comprising from 20 to 40 parts by mass of pentaerythritol, from 20 to 40 parts by mass of dicyandiamide and from 0.2 to 0.6 parts by mass of propylene glycol, per 100 parts by mass of ammonium chloride, and not containing sodium tungstate, ammonium sulfate, urea formaldehyde and ammonium monophosphate.

2. A liquid fire retardant comprising from 1.0 to 30.0% by mass of ammonium chloride, from 0.5 to 10.0% by mass of pentaerthrytol, from 0.5 to 10.0% by mass of dicyandiamide, from 0.01 to 0.2% by mass of propylene glycol and from 49.8 to 97.99% by mass of water and not containing sodium tungstate, ammonium sulfate, urea formaldehyde and ammonium monophosphate.

3. The liquid fire retardant of claim 2 diluted with water from 2 to 20 times and then used.

4. A method of preparing a fire retardant foam using the powdery fire retardant according to claim 1, wherein said powdery fire retardant is mixed with a foamable material and then the resultant mixture is foamed.

5. A method of preparing a fire retardant foam using the powdery fire retardant according to claim 1, wherein an amount of from 0.1 to 40% by mass of said powdery fire retardant based on the total amount of an aqueous solution of said powdery fire retardant is dissolved in water and a foam is impregnated with the resultant aqueous solution of the powdery fire retardant and dried.
